(19) United States
(12) Patent Application Publication
(10) Pub. No.: US 2012/0320077 A1
(43) Pub. Date: Dec. 20, 2012

(54) COMMUNICATING STATUS AND EXPRESSION

(75) Inventors: Glen C. Larsen, Issaquah, WA (US); Russell Sanchez, Seattle, WA (US)

(73) Assignee: Microsoft Corporation, Redmond, WA (US)

(21) Appl. No.: 13/162,892

(22) Filed: Jun. 17, 2011

(51) Int. Cl. G09G 5/10; G03B 21/14

(52) U.S. Cl. 345/589; 345/690; 353/30; 901/50

(57) ABSTRACT

There is provided a robot that includes a processor executing instructions that determine a desired image to be displayed. The processor issues control signals corresponding to the desired image to be displayed. The robot also comprises a display assembly including a plurality of light sources, and a display surface. Selected ones of the plurality of light sources are activated depending at least in part upon the control signals. The display assembly includes a plurality of first light-carrying members. Each of the first light-carrying members transfers light from a corresponding one of the light sources to a light-carrying member to produce the desired image to be displayed on the display surface.

### BACKGROUND

In the field of applied robotics, expression of emotion may be emulated by robots in several ways. For example, machine-like indicators, such as status indicators or lights, are often used in robotic systems to represent various emotional states of a robotic device. Symbolic methods are also sometimes used in robotic systems to display symbols or patterns of symbols that represent various conditions and/or emotional states of a robotic device. Further, anthropomorphic methods are also sometimes used in robotic systems to convey emotional states of a robotic device, such as, for example, by emulating human facial features and/or expressions.

The machine-like and symbolic indicators are often disfavored since they require a user or person interfacing with a robot to consciously translate or interpret the displayed indicator or symbols in order to determine the corresponding indicated state of the robotic device. Conversely, the anthropomorphic method is capable of conveying an emotional state of a robotic device to a person interfacing with the device without requiring interpretation or translation in order for that person to determine the corresponding indicated state of the robotic device.

However, the anthropomorphic method may give a person interfacing with the robotic device the false impression that the device has certain human capabilities, such as, for example, the ability to engage in or comprehend conversational speech. Such an effect or false impression is sometimes referred to as the “uncanny valley” effect, which is a term used to describe an unfavorable perception or reaction that may occur in humans when interacting with robots or other facsimiles of humans that look and act almost like actual humans. The “valley” refers to a dip in a graph of the positivity of human reaction as a function of a robot's lifelikeness. The “uncanny valley” effect and the associated false impression of the capabilities of a robotic device may result in difficult or inefficient interactions with the robotic device.

### SUMMARY

The following is a brief summary of subject matter that is described in greater detail herein. This summary is not intended to be limiting as to the scope of the claims. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter generally provides a robot having a display with regions wherein different degrees of blending of the image to be displayed occur. One embodiment of the claimed subject matter relates to a robot having a processor that executes instructions that determine, and issues control signals corresponding to, a desired image to be displayed. The robot also includes a display assembly having a plurality of light sources, and a display surface. Selected ones of the plurality of light sources are activated dependent at least in part upon the control signals. The display assembly includes a plurality of first light-carrying members, each of which transfer light from a corresponding light source to a second light-carrying member to thereby produce the desired image on the display surface.

Another embodiment of the claimed subject matter relates to a display assembly that includes a plurality of light sources, an illumination lens and a display surface. The illumination lens includes a plurality of first light-carrying members, each of which transfer light from a corresponding one of the light sources to a second light-carrying member. The display surface receives light corresponding to an image to be displayed from the second light-carrying member.

Yet another embodiment of the claimed subject matter relates to a method of forming a display image including regions having regions with different degrees of blending. The method includes receiving an image display request, and activating individual light sources to emit light in response to the image display request. The light generated by each of the activated light sources is transferred to a light-carrying member. The light is blended together to different and predetermined degrees within corresponding different and predetermined regions of the light-carrying member.

### BRIEF DESCRIPTION OF THE DRAWINGS

FIG. 1 is a block diagram of a robot having one embodiment of a display system according to the subject innovation;

FIG. 2 is a block diagram of a display system according to the subject innovation;

FIG. 3 is an exploded view of the display assembly of FIG. 2;

FIG. 4 is a perspective view of the illumination lens of FIG. 3; and

FIG. 5 is a flow diagram that illustrates a method of forming a display image including regions having different degrees of blending according to the subject innovation.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

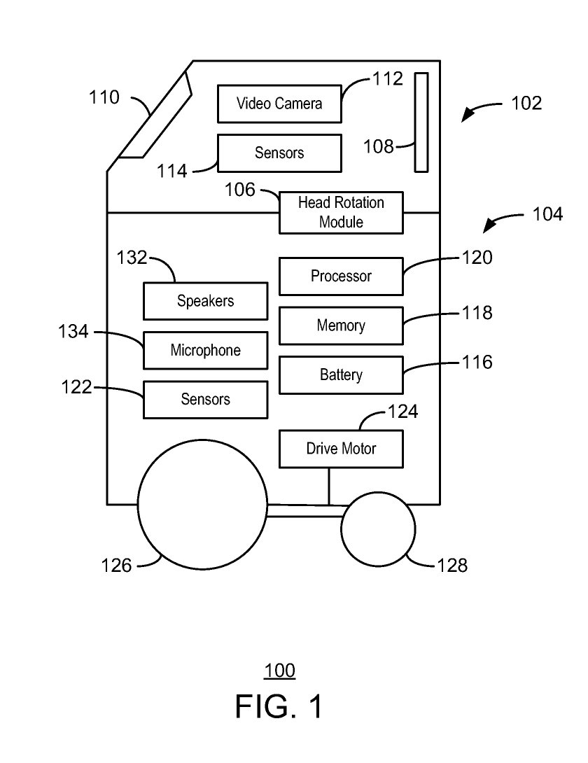

FIG. 1 is a block diagram of a robotic device or “robot” 100 capable of communicating with a remotely-located computing device by way of a network connection. A “robot”, as the term will be used herein, is an electro-mechanical machine that includes computer hardware and software that causes the robot to perform functions independently and without assistance from a user. The robot 100 can include a head portion 102 and a body portion 104, wherein the head portion 102 is movable with respect to the body portion 104. The robot 100 can include a head rotation module 106 that operates to couple the head portion 102 with the body portion 104, wherein the head rotation module 106 can include one or more motors that can cause the head portion 102 to rotate with respect to the body portion 104. As an example, the head rotation module 106 may rotate the head portion 102 with respect to the body portion 104 up to 45° in either direction. In another example, the head rotation module 106 can allow the head portion 102 to rotate 90° in either direction relative to the body portion 104. In yet another example, the head rotation module 106 can allow the head portion 102 to rotate 90° in either direction relative to the body portion 104. In still yet another example, the head rotation module 106 can facilitate rotation of the head portion 102 190° in either direction with respect to the body portion 104. The head rotation module 106 can facilitate rotation of the head portion 102 with respect to the body portion 102 in either angular direction.

The head portion 102 may include an antenna 108 that is configured to receive and transmit wireless signals. For instance, the antenna 108 can be configured to receive and transmit Wi-Fi signals, Bluetooth signals, infrared (IR) signals, sonar signals, radio frequency (RF), signals or other suitable signals. The antenna 108 can be configured to receive and transmit data to and from a Cellular tower, the Internet or the cloud in a cloud computing environment. Further, the robot 100 may communicate with a remotely-located computing device, another robot, control device, such as a handheld, or other devices (not shown) using the antenna 108.

The head portion 102 of the robot 100 also includes one or more display systems 110 configured to display information to an individual that is proximate to the robot 100. The display system 110 is more particularly described hereinafter.

A video camera 112 disposed on the head portion 102 may be configured to capture video of an environment of the robot 100. In an example, the video camera 112 can be a high definition video camera that facilitates capturing video and still images that are in, for instance, 720p format, 720i format, 1080p format, 1080i format, or other suitable high definition video format. The video camera 112 can be configured to capture relatively low resolution data in a format that is suitable for transmission to the remote computing device by way of the antenna 108. As the video camera 112 is mounted in the head portion 102 of the robot 100, through utilization of the head rotation module 106, the video camera 112 can be configured to capture live video data of a relatively large portion of an environment of the robot 100.

The robot 100 may further include one or more sensors 114. The sensors 114 may include any type of sensor that can aid the robot 100 in performing autonomous or semi-autonomous navigation. For example, these sensors 114 may include a depth sensor, an infrared sensor, a camera, a cliff sensor that is configured to detect a drop-off in elevation proximate to the robot 100, a GPS sensor, an accelerometer, a gyroscope, or other suitable sensor type.

The body portion 104 of the robot 100 may include a battery 116 that is operable to provide power to other modules in the robot 100. The battery 116 may be, for instance, a rechargeable battery. In such a case, the robot 100 may include an interface that allows the robot 100 to be coupled to a power source, such that the battery 116 can be recharged.

The body portion 104 of the robot 100 can also include one or more computer-readable storage media, such as memory 118. A processor 120, such as a microprocessor, may also be included in the body portion 104. As will be described in greater detail below, the memory 118 can include a number of components that are executable by the processor 120, wherein execution of such components facilitates controlling and/or communicating with one or more of the other systems and modules of the robot. The processor 120 can be in communication with the other systems and modules of the robot 100 by way of any suitable interface, such as a bus hosted by a motherboard. In an embodiment, the processor 120 functions as the “brains” of the robot 100. For instance, the processor 120 may be utilized to process data received from a remote computing device as well as other systems and modules of the robot 100 and cause the robot 100 to perform in a manner that is desired by a user of such robot 100.

The body portion 104 of the robot 100 can further include one or more sensors 122, wherein such sensors 122 can include any suitable sensor that can output data that can be utilized in connection with autonomous or semi-autonomous navigation. For example, the sensors 122 may include sonar sensors, location sensors, infrared sensors, a camera, a cliff sensor, and/or the like. Data that is captured by the sensors 122 and the sensors 114 can be provided to the processor 120, which can process the data and autonomously navigate the robot 100 based at least in part upon the data output.

A drive motor 124 may be disposed in the body portion 104 of the robot 100. The drive motor 124 may be operable to drive wheels 126 and/or 128 of the robot 100. For example, the wheel 126 can be a driving wheel while the wheel 128 can be a steering wheel that can act to pivot to change the orientation of the robot 100. Additionally, each of the wheels 126 and 128 can have a steering mechanism to change the orientation of the robot 100. Furthermore, while the drive motor 124 is shown as driving both of the wheels 126 and 128, it is to be understood that the drive motor 124 may drive only one of the wheels 126 or 128 while another drive motor can drive the other of the wheels 126 or 128. Upon receipt of data from the sensors 114 and 122 and/or receipt of commands from the remote computing device (for example, received by way of the antenna 108), the processor 120 can transmit signals to the head rotation module 106 and/or the drive motor 124 to control orientation of the head portion 102 with respect to the body portion 104, and/or to control the orientation and position of the robot 100.

The body portion 104 of the robot 100 can further include speakers 132 and a microphone 134. Data captured by way of the microphone 134 can be transmitted to the remote computing device by way of the antenna 108. Accordingly, a user at the remote computing device can receive a real-time audio/video feed and may experience the environment of the robot 100. The speakers 132 can be employed to output audio data to one or more individuals that are proximate to the robot 100. This audio information can be a multimedia file that is retained in the memory 118 of the robot 100, audio files received by the robot 100 from the remote computing device by way of the antenna 108, real-time audio data from a web-cam or microphone at the remote computing device, etc.

While the robot 100 has been shown in a particular configuration and with particular modules included therein, it is to be understood that the robot can be configured in a variety of different manners, and these configurations are contemplated and are intended to fall within the scope of the hereto-appended claims. For instance, the head rotation module 106 can be configured with a tilt motor so that the head portion 102 of the robot 100 can tilt up and down within a vertical plane and pivot about a horizontal axis. Alternatively, the robot 100 may not include two separate portions, but may include a single unified body, wherein the entire robot body can be turned to allow the capture of video data by way of the video camera 112. In still yet another embodiment, the robot 100 can have a unified body structure, but the video camera 112 can have a motor, such as a servomotor, associated therewith that allows the video camera 112 to alter position to obtain different views of an environment. Modules that are shown to be in the body portion 104 can be placed in the head portion 102 of the robot 100, and vice versa. It is also to be understood that the robot 100 has been provided solely for the purposes of explanation and is not intended to be limiting as to the scope of the hereto-appended claims.

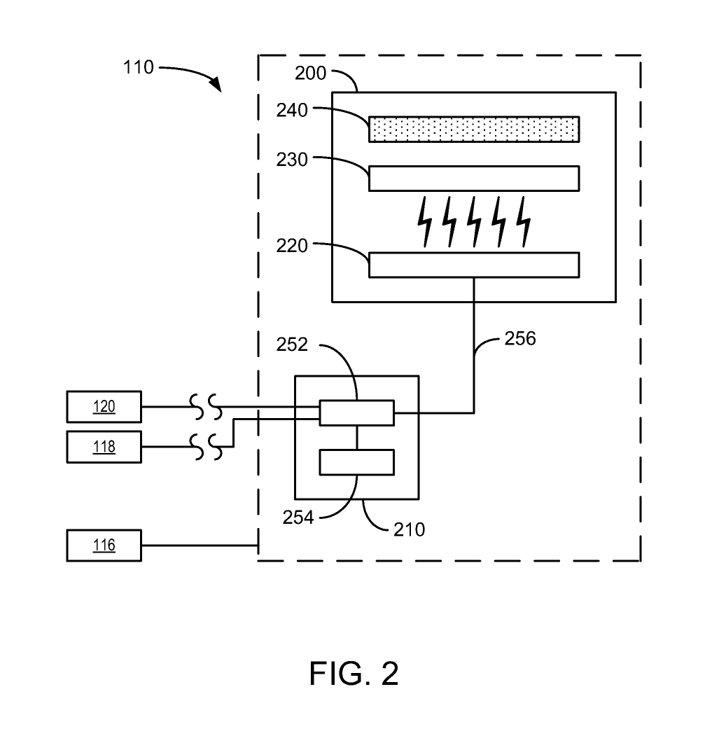

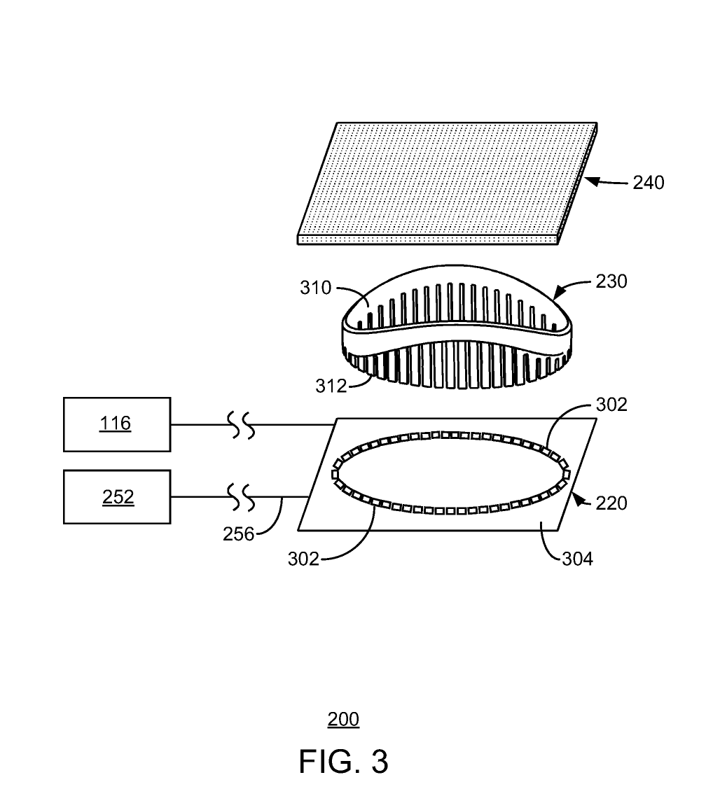

FIG. 2 is a block diagram of one embodiment of a display system 110. As explained herein, an example embodiment of the subject innovation allows the robot 100 to display an indication of status or emotion via the display system 110. The display system 110 is connected to and powered by the battery 116, and includes a display assembly 200 and a display control unit (DCU) 210. The display assembly 200 includes a light source assembly 220, an illumination lens 230 and a display surface 240, each of which are more particularly described hereinafter with reference to FIG. 3.

The DCU 210 includes a DCU processor 252 and a DCU memory 254. The DCU processor 252 may include a microprocessor, which communicates with processor 120 and is capable of accessing the memory 118, either directly or via the processor 120. The DCU memory 254 may include read only memory, hard disk memory, and the like, which stores a plurality of components that are accessible to and executable by the DCU processor 252 to control the operation of the display assembly 200 via control signals 256. Further, the DCU memory 254 is accessible by the DCU processor 252 for the purposes of writing data to and reading data. The display system 110 can be configured to allow the processor 120 to directly control the display assembly 200 by executing one or more components stored within memory 118.

With reference now to FIG. 3, an exploded view of the display assembly 200 is shown. In the illustrated embodiment, the light source assembly 220 includes a plurality of individual light sources 302, such as light emitting diodes, arranged in a generally oval pattern on or integral with a substrate 304, such as a printed circuit board. Alternatively, the light sources 302 can be arranged in any desired pattern or two-dimensional array based upon the desired shapes and characteristics of the images and/or information to be displayed. The substrate 304 includes the interconnections, such as printed circuit traces, that interconnect each of the light sources 302 with other components, including power from the battery 116 and the control signals 256 from the DCU processor 252. The control signals 256 can control the state of illumination (i.e., on or off), the level of intensity, brightness, and color at which each of the light sources 302 is individually and separately illuminated.

The illumination lens 230, in the embodiment illustrated, may also be generally annular or oval in shape to correspond with the arrangement of the light sources 302 and includes a common (or second) light-carrying member 310 and a number of first light-carrying members 312. The common light-carrying member 310 and the first light-carrying members 312 may include, for example, light tubes or pipes. The common light-carrying member 310 is associated with each of the first light-carrying members 312 such that light travels through each of first light-carrying members 312 into a portion of the common light-carrying member 310. In the embodiment shown, the illumination lens 230 and the common light-carrying member 310 are generally annular in shape. The illumination lens 230 and the common light-carrying member 310 may take various other shapes, such as an arc, a semicircle, a square, a line, a polygon, or virtually any other two or three dimensional shape, to correspond with the arrangement of the light sources 302. The shapes may be selected based upon the desired shape and characteristics of the images and/or information to be displayed.

Further, in yet another embodiment, the first light-carrying members 312 may be mechanically associated or joined into an assembly of first light-carrying members 312 to thereby form an illumination lens. In this embodiment, there may be no common light-carrying member 310 associated with the first light-carrying members 312. Rather, in this embodiment, each of the first light-carrying members 312 may be said to include a respective common or second light-carrying member 310, which may have the same or different internal light transmission or reflection properties relative to the first light-carrying members 312. Thus, the term common-light carrying member 310 as used herein shall not be construed as being limited to a light-carrying member that is common with, or receives light from, more than one first light-carrying member 312. In an alternate embodiment, there may be two or more common light-carrying members 310 each of which is associated with a respective subset of first light-carrying members 312 to thereby blend together within the common light-carrying members 310 the light from the corresponding subset of light sources 302.

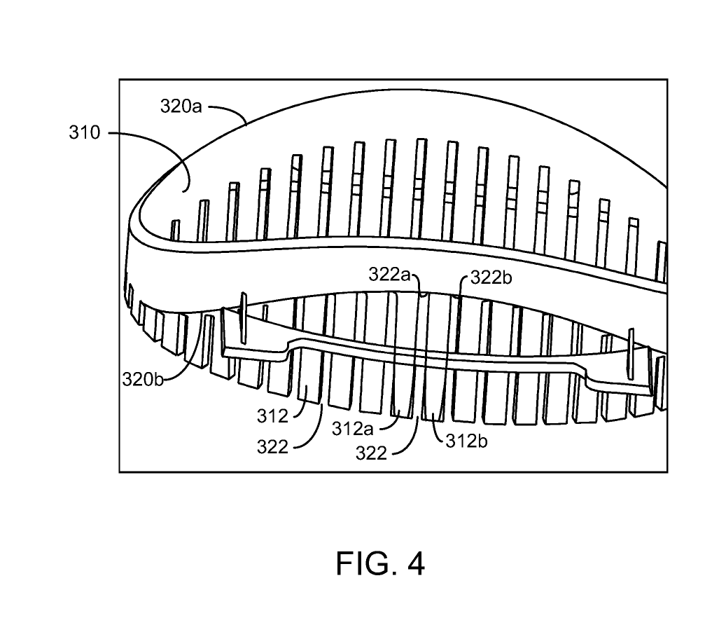

With reference now to FIG. 4, the illumination lens 230 is illustrated in more detail. The common light-carrying member 310 includes top surface 320a and a bottom surface 320b. In this embodiment, the common light-carrying member 310 is generally annular or oval in its overall shape. Each of the first light-carrying members 312 includes an elongate member that has a first end associated with the common light-carrying member 310 and an opposite end disposed remotely from the common light-carrying member 310. The ends of the first light-carrying members 312 that are opposite and remote from common light-carrying member 310 are disposed generally in a common plane or in a contour that is configured to conform to a contour of the substrate 304 and/or the light sources 302 thereon.

As is shown by first light-carrying members 312a and 312b, each of the first light-carrying members 312 is generally parabolic in shape with the ends remote from the common light-carrying member 310 being narrower or having a smaller cross-sectional area than the portions thereof that are proximate to the common light-carrying member 310. Alternatively, each of first light-carrying members 312 is parabolically conical in shape with a cross-sectional area that increases from the remote ends of the first light-carrying members 312 toward the common light-carrying member 310. In other embodiments, the light-carrying members 312 may have the same or different shapes that facilitate transfer via total internal reflection of the light from the light sources 302 to the display surface 240.

Each of the first light-carrying members 312 is spaced apart from one another. Notches 322 may be used to separate adjacent first light-carrying members 312 from each other. The notches 322 may include elongate notches having first ends or openings adjacent the ends of first light-carrying members 312 that are remote from common light-carrying member 310 and second ends that terminate at or proximate to the common light-carrying member 310. This is illustrated in FIG. 4 by the second ends 322a and 322b of the notches 322. Alternatively, and for reasons that will be more particularly described hereinafter, the second ends 322a and 322b of the notches 322 can terminate at various distances from the common light-carrying member 310 to thereby produce a variety of different display characteristics.

The display surface 240 (FIG. 3) may include a translucent or optically tinted member that may be planar, curved or otherwise configured to be suitable for the intended location of light assembly 200 on robot 100. In an example embodiment, the display surface 240 may exhibit a complex shape such as a compound curvature. The display surface 240 conceals the illumination lens 230 and the other internal components of the light assembly 200 from view, yet permits illumination from the light sources 302, which emanates from the illumination lens 230, to be visible.

In use, the processor 120 may respond to data from the sensors 114 and 122, commands from a remote computing device (received by way of the antenna 108), or spoken or otherwise issued commands, and transmit signals to control the display assembly 200, directly or via the DCU 210, and thereby the display appearing on the display surface 240. More particularly, in the case of indirect control via the DCU 210, the processor 120 transmits to the DCU processor 252 signals that indicate a desired display, such as a display emulating open eyes and/or a smile, appears on the display surface 240. The DCU processor 252, in turn, executes one or more components or routines from the DCU memory 254 that correspond to the desired image to be displayed on the display surface 240. The DCU processor 252 may then issue control signals 256 to the light source assembly 220 to activate one or more individual light sources 302 in a manner and/or pattern corresponding to the desired display.

The activated individual light sources 302 emit light which enters the ends of the corresponding first light-carrying members 312 that are remote from the common light-carrying member 310. The light travels through the first light-carrying members 312 and into a portion of the common light-carrying member 310. The light entering the common light-carrying member 310 from each of the first light-carrying members 312 that correspond to an activated light source may then blend together within the common light-carrying member 310 and then emanate from illumination lens 230 onto and/or through display surface 240. The blended light may then be visible to an observer of the display system 110.

Within the common light-carrying member 310, the light from the first light-carrying members 312 blends together to a degree determined at least in part by the “depth” of the notches 322, i.e., the distance from the first end or opening of the notches 322 that are remote from the common light-carrying member 310 and second ends 322a, 322b that are disposed more proximate to the common light-carrying member 310. In other words, the amount or degree of blending that is achieved by illumination lens 230 is determined at least in part by the contour of the top and bottom surfaces 320a, 320b of common light-carrying the member 310 relative to the first end or opening of the notches 322, thereby in effect determining the “depth” of the notches 322.

In the exemplary embodiment shown, the top and bottom surfaces 320a, 320b have matching contours, and as a result, the notches 322 on opposing sides or portions of common light-carrying member 310 are of approximately the same depth. Thus, the degree of blending achieved by the illumination lens 230, in the example embodiment shown, is approximately the same on opposing sides or portions of the common light-carrying member 310. However, it is to be understood that the illumination lens 230 can be alternately configured to change the degree of blending. For example, a common light-carrying member 310 may have a top and bottom surfaces 320a, 320b contoured to change the regional or localized depths of the notches 322 and, thereby, produce regions of the illumination lens 230 that have different degrees of blending of the light. However, as the degree of blending or uniformity of the illumination lens 230, or regions thereof, is increased the resolution or ability to discern individual light sources 302 in those same regions is decreased.

The different degrees of blending achieved by the illumination lens 230 and, thus, of the light emanating there from, which is then displayed on the display surface 240, enables display of images, such as, for example, human-like features of eyes, mouth, ears, and facial expressions, by using regions of the illumination lens 230 having appropriate degrees of blending to form the desired features to be displayed. Such displayed images do not require any conscious translation by a viewer and yet reduce the undesirable “uncanny valley” effect when the robot 100 is interacting with a human user. Further, display assembly 200 enable the display of a wide variety of emotionally-expressive images that can resemble facial expressions, and yet are enhance a viewer's ability to interact with the robot 100 because the displayed images, or facial expressions, are not literally anthropomorphic but rather are symbolic representations of human facial and other expression.

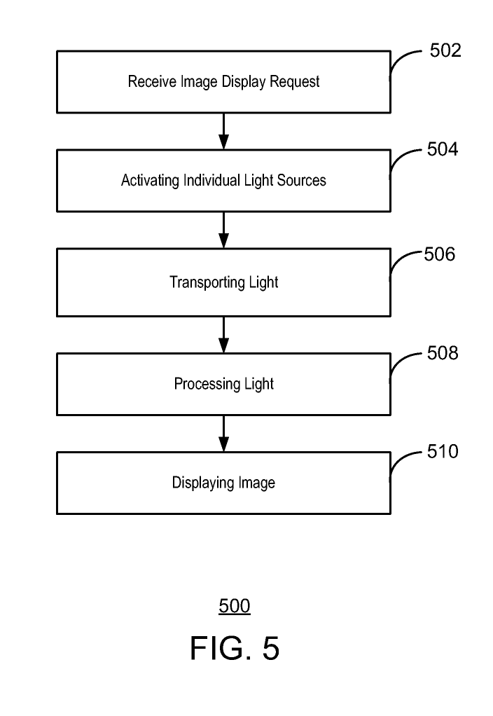

FIG. 5 is a process flow diagram of a method 500 of controlling the degree of blending in an image to be displayed. The method 500 includes receiving an image display request 502, activating individual light sources 504, transporting the light 506, processing the light 508 and displaying the image 510.

Receiving an image display request 502 includes a processor, such as the processor 120 or the DCU processor 252, sending to a display assembly control signals which correspond to a desired image to be displayed. Activating the individual light sources 504 via the received control signals causes the individual light sources corresponding to the desired display image to be illuminated and emit light. Transporting light 506 includes transporting via first light-carrying members, corresponding to each light source, the light emitted by the light sources to a light processing member. Processing light 508 generally includes preparing the light received for external display.

In one embodiment, transporting light 506 transports the light from the individual light sources 302 via individual first light-carrying members 312 into a common light processing member, such as a common light-carrying member 310. The common light processing member thus receives at least a portion of the light emitted by each activated individual light source 302. The degree to which the light received by the common light processing member is processed or blended together is determined at least in part by the characteristics of the common light processing member.

More particularly, in the embodiment shown, the degree of blending is determined at least in part by the “depth” of the notches 322, i.e., the distance from the first ends or openings of the notches 322 that are remote from the common light-carrying member 310 and the second ends (e.g., 322a, 322b) that terminate more proximate to the common light-carrying member 310. Alternatively stated, the amount or degree of blending that is achieved by the illumination lens 230 is determined at least in part by the contour of bottom surface 320b of the common light-carrying member 310 relative to the ends of the first light-carrying members that are disposed remotely from the common light-carrying member 310. This contour, in turn, determines the effective “depth” of the notches 322. As the depth of the notches 322 increases, the resolution of the resulting display, or the ability to discern individual and distinct activated light sources on the resulting display, also increases whereas the uniformity or amount of blending of the light sources displayed decreases. Conversely, as the depth of the notches 322 decrease, the resolution of the resulting display, or the ability to discern individual and distinct activated light sources on the resulting display, decreases whereas the uniformity or amount of blending of the light sources displayed increases. Thus, by varying the depth of notches corresponding to localized or regional portions of the illumination lens 230, areas having predetermined amounts of blending and/or resolution can be defined within the illumination lens 230 and, thereby, on the image displayed on the display surface 240. Displaying the image 510 includes displaying the desired display image, for example, on the display surface 240.

While the systems, methods and flow diagram described above have been described with respect to robots, it is to be understood that various other devices that utilize or include display technology can utilize aspects described herein. For instance, various industrial equipment, automobile displays, and the like may apply the inventive concepts disclosed herein.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A robot, comprising:
a processor executing instructions that determine a desired image to be displayed, the processor issuing control signals corresponding to the desired image to be displayed; and
a display assembly including a plurality of light sources, and a display surface, selected ones of the plurality of light sources being activated dependent at least in part upon the control signals, the display assembly including a plurality of first light-carrying members, each of the first light-carrying members transferring light from a corresponding one of the light sources to a second light-carrying member to produce the desired image to be displayed on the display surface.

2. The robot of claim 1, further comprising notches defined by an illumination lens, the notches being disposed between and separating at least in part the first light-carrying members from adjacent first light-carrying members.

3. The robot of claim 2, wherein the first light-carrying members include respective first and second ends, the first ends disposed remotely from the second light-carrying member, the second ends disposed adjacent the second light-carrying member, the notches extending a predetermined distance from the first ends toward the second ends.

4. The robot of claim 2, wherein the first light-carrying members include respective first and second ends, the first ends disposed remotely from the second light-carrying member, the second ends disposed adjacent the second light-carrying member, the notches extending from the first ends to the second ends.

5. The robot of claim 4, wherein the second light-carrying member is configured to determine at least in part a distance between the first and second ends of the plurality of first light-carrying members.

6. The robot of claim 5, wherein the second light-carrying member has a predetermined contour relative to the first and second ends of the first light-carrying members.

7. The robot of claim 6, wherein the second light-carrying member has generally opposing surfaces, the generally opposing surfaces forming the predetermined contour.

8. The robot of claim 2, wherein the first light-carrying members include respective first and second ends, the first ends disposed remotely from the second light-carrying member, the second ends disposed one of proximate and adjacent to the second light-carrying member, the first light-carrying members being generally parabolic in shape from the first ends to the second ends, with the first ends having a smaller cross-sectional area than a cross-sectional area of the second ends.

9. The robot of claim 1, wherein the light-carrying member is common for the plurality of light sources.

10. A display assembly, comprising:
a plurality of light sources;
an illumination lens including a plurality of first light-carrying members, each of the first light-carrying members configured for transferring light from a corresponding one of the light sources to a second light-carrying member; and
a display surface that receives light corresponding to an image to be displayed from the second light-carrying member.

11. The display assembly of claim 10, further comprising notches defined by the illumination lens, the notches being disposed between and separating at least in part the first light-carrying members from adjacent first light-carrying members.

12. The display assembly of claim 11, wherein the first light-carrying members include respective first and second ends, the first ends disposed remotely from the second light-carrying member, the second ends disposed adjacent the second light-carrying member, the notches extending a predetermined distance from the first ends to the second ends.

13. The display assembly of claim 11, wherein the first light-carrying members include respective first and second ends, the first ends disposed remotely from the second light-carrying member, the second ends disposed adjacent the second light-carrying member, the notches extending from the first ends to the second ends.

14. The display assembly of claim 13, wherein the second light-carrying member is configured to determine at least in part a distance between the first and second ends of the plurality of first light-carrying members.

15. The display assembly of claim 14, wherein the second light-carrying member has a predetermined contour relative to the first and second ends of the first light-carrying members.

16. The display assembly of claim 15, wherein the second light-carrying member has generally opposing surfaces, the generally opposing surfaces forming the predetermined contour.

17. The display assembly of claim 10, wherein the first light-carrying members include respective first and second ends, the first ends disposed remotely from the second light-carrying member, the second ends disposed one of proximate and adjacent to the second light-carrying member, the first light-carrying members being generally parabolic in shape from the first ends to the second ends, the first ends having a smaller cross-sectional area than a cross-sectional area of the second ends.

18. The display assembly of claim 10, wherein the second light-carrying member comprises a common light-carrying member.

19. The display assembly of claim 10, wherein the display surface comprises a complex shape.

20. A method of forming a display image including regions having different degrees of blending, comprising:
receiving an image display request;
activating individual light sources to emit light in response to the image display request;
transferring the light emitted by each of the one or more light sources into a light processing member; and
processing by blending together to different and predetermined degrees the light emanating from corresponding different and predetermined regions of the light processing member.
